(19) United States
(12) Patent Application Publication
(10) Pub. No.: US 2004/0149520 A1
(43) Pub. Date: Aug. 5, 2004

(54) Inground lift

(76) Inventors: Bryan Taylor, Madison, IN (US); David Porter, Madison, IN (US)

Correspondence Address: FROST BROWN TODD, LLC, 2200 PNC CENTER, 201 E. FIFTH STREET, CINCINNATI, OH, 45202, US

(21) Appl. No.: 10/667,876

(22) Filed: Sep. 22, 2003

Related U.S. Application Data
(60) Provisional application No. 60/412,483, filed on Sep. 20, 2002.

(51) Int. Cl. B66F 7/00

(52) U.S. Cl. 187/203

(57) ABSTRACT

A modular inground lift is supported by the lift bay floor. The lift includes self contained modules which have their own power units. A telescoping cylinder and locking leg allow the depth of the lift to be shallower than before. The use of VFD to control the motors allows monitoring of the loads, both during raising and lowering. The modular lift includes integral rebar to provide the structural connection with the lift bay floor.

### BACKGROUND OF THE INVENTION

This application claims priority from U.S. Provisional Patent Application Serial No. 60/412,483, filed Sep. 20, 2002, which is incorporated herein by reference. This application hereby incorporates by reference U.S. patent application Ser. No. 09/884,673, filed Jun. 19, 2001, titled Removable Cylinder Arrangement For Lift, U.S. patent application Ser. No. 10/055,800, filed Oct. 26, 2001, titled Electronically Controlled Vehicle Lift And Vehicle Service System, U.S. patent application Ser. No. 10/056,985, filed Jan. 25, 2002, titled System for Detecting Liquid In An Inground Lift, and U.S. patent application Ser. No. 10/123,083, filed Apr. 12, 2002, titled Method And Apparatus For Synchronizing A Vehicle Lift, all of which are commonly owned herewith.

Heavy duty inground lifts are well known in the art. Such lifts typically have at least a pair of spaced apart cylinder located at least partially within a below ground pit. It is also know to have more than two spaced apart jacks in a single bay.

Depending on the needs, typically one of these jacks is fixed in place and the others are moveable longitudinally, within an elongated pit. The moveable jack is typically carried by a trolley which is supported by spaced apart tracks located slightly below the level of the floor or other surface surrounding the lift. It is known for the lift housing to be made from concrete walls and floor poured in place in a trench, or to be a self contained containment housing which in disposed in a trench. In either case, the tracks are disposed atop the walls in a manner that the force from the load on the jack is transmitted to the housing walls, and through the housing walls to the housing floor, which in turn is supported by the soil and gravel located in the pit. In this configuration, it is the bottom of the pit that provides the support for the jacks to carry the vehicle.

Single stage cylinders require the lift pit to be dug over ten feet deep. The construction of a concrete pit can take about three months due to the cure time of the concrete and the sequential timing of pouring the pit floor, pit walls and the floor.

### BRIEF DESCRIPTION OF THE DRAWING

The accompanying drawings incorporated in and forming a part of the specification illustrate several aspects of the present invention, and together with the description serve to explain the principles of the invention. In the drawings:

FIG. 1 is a perspective, partially cut-away view of a heavy duty inground lift according to teachings of the present invention.

FIG. 2 is a perspective, exterior view of the inground lift of FIG. 1.

FIGS. 3 and 4 illustrate typical equipment foundation requirements.

FIG. 5 includes a top, side, and end view of the housing, and an enlarged fragmentary view of overlapping sections of the housing of the inground lift of FIG. 1.

FIG. 6 is a cross-sectional view through the housing of the inground lift of FIG. 1, showing the carriage supported by the side tracks.

FIG. 7 is a cross-sectional view through a telescoping cylinder of the inground lift of FIG. 1.

FIG. 8 is a diagrammatic illustration of a hydraulic circuit of the inground lift of FIG. 1.

FIG. 9 is a perspective view of the telescoping locking leg of the inground lift of FIG. 1.

FIG. 10 is a perspective view of the telescoping locking leg of FIG. 9.

FIG. 11 is an enlarged, fragmentary view of the upper locking mechanism illustrated at detail A of FIG. 10.

FIG. 12 is a top view of the upper locking mechanism of FIGS. 10 and 11.

FIG. 13 is a fragmentary cross-sectional view of the telescoping locking legs taken along line B-B of FIG. 12.

FIG. 14 is a perspective view of the control panel of the of the inground lift of FIG. 1.

FIG. 15 is a perspective view of an alternate control panel of the inground lift of FIG. 1.

FIG. 16 illustrates rate of adjustment versus the angle of the joystick.

Reference will now be made in detail to the present preferred embodiment of the invention, an example of which is illustrated in the accompanying drawings.

### DETAILED DESCRIPTION OF THE INVENTION

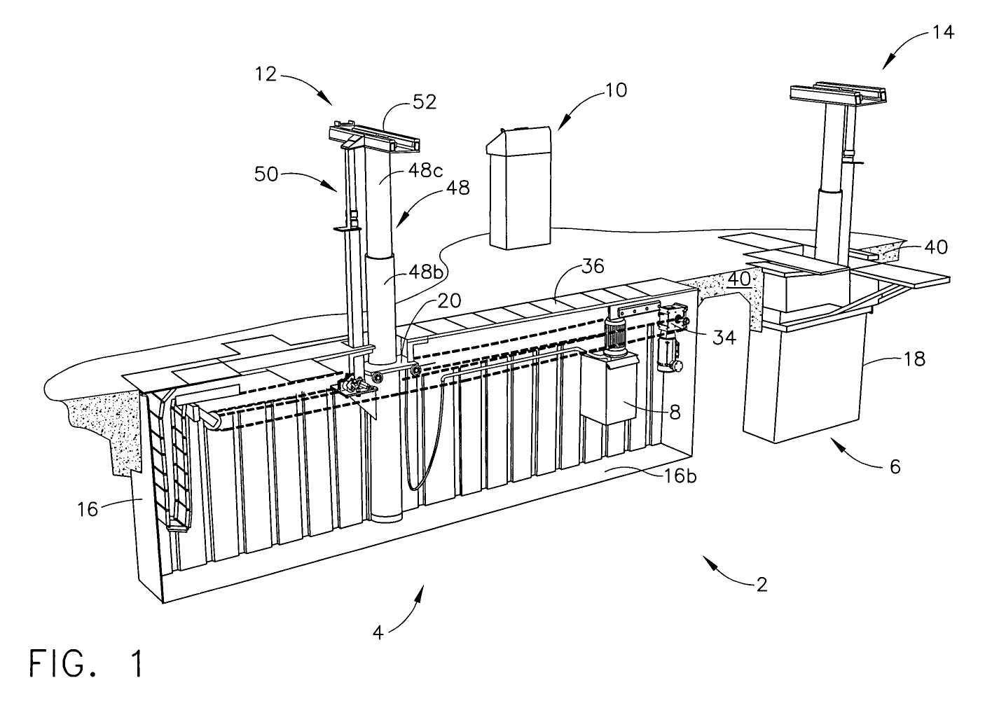

Referring now to the drawings in detail, wherein like numerals indicate the same elements throughout the views, FIG. 1 is a is a perspective, partially cut-away view of a heavy duty inground lift 2 including two modules 4 and 6, each having its own respective power unit (seen only in module 4 as power unit 8). The depicted embodiment has a capacity of 30,000 lbs. Lift 2 includes control panel 10, located in any desired location.

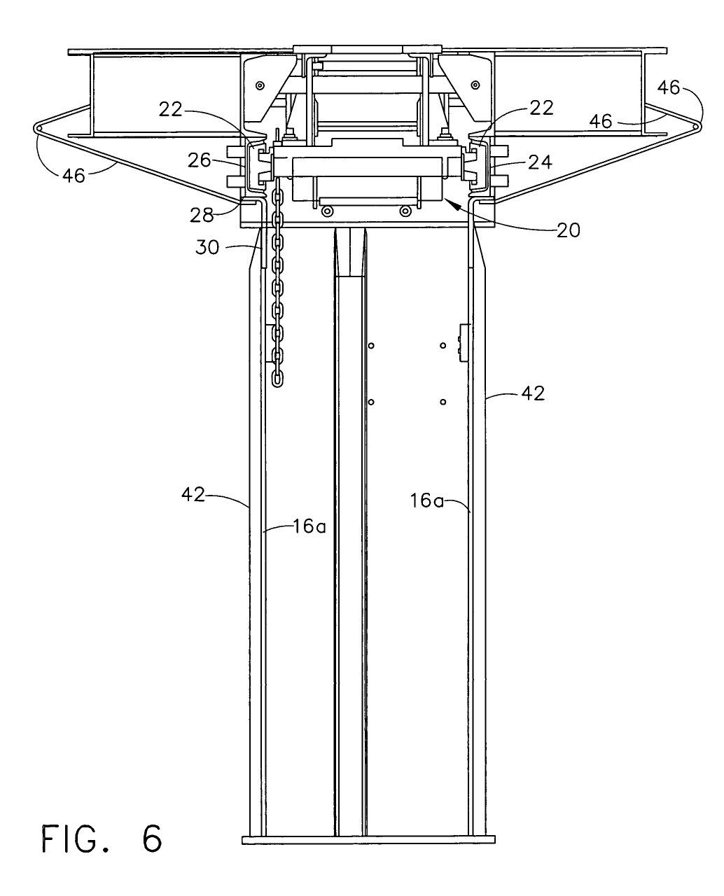

Modules 4 and 6 includes respective telescoping jacks 12 and 14, the construction and operation of which is substantially the same, although jack 12 is moveable longitudinally within housing 16 while jack 14 is fixed within housing 18. The mechanism of jack 12 that allows longitudinal movement is well known in the art. Jack 12 is carried by carriage or trolley 20, as seen also in FIG. 6, and includes wheels 22 supported by spaced apart tracks 24 and 26. Tracks 24 and 26 are each an inwardly opening channel having a generally “C” shaped cross section, in which the wheels 22 are located. The lower, horizontal legs of tracks 24 and 26 surmount a member having a 90° cross section, with one leg 28 underlying the track and a longer, downwardly depending leg 30 oriented generally vertically. Leg 30 is secured to sidewalls 16a of housing 16.

Carriage 20 is moved by chains 32 which are ultimately driven by driven by the hydraulic motor and gear reducer assembly 34 located as appropriate, in the depicted embodiment at one end of housing 16. Moving shingles 36 travel with carriage 20, covering the top of housing 16 regardless of the location of jack 12. The horizontal position of jack 12 is monitored by any appropriate device, such as string potentiometer, diagrammatically illustrated as 38, secured at one end to a fixed location.

In the present invention, all the support for the load carried by jacks 12 and 14 is provided the lift bay floor 40, rather than the sidewalls 16a and the bottom of the trench. The present invention includes structure which interact in conjunction with the lift bay floor 40 to transfer substantially all of the load to the lift bay floor 40. In the depicted embodiment, floor 40 is constructed to have the necessary structural capacity with the necessary underlying supporting layer providing the foundational support.

Since sidewalls 16a (including the endwalls) do not carry the load from jack 12, they are not vertically load bearing. The sidewalls 16a are thus constructed to resist external side and bottom loads to maintain the integrity of the cavity, and to contain fluids as well as to keep groundwater out. A liquid detecting system, as disclosed in U.S. patent application Ser. No. 10/056,985 for System for Detecting Liquid In An Inground Lift may be utilized.

As can be seen in FIGS. 1-6, sidewalls 16a have been strengthened, in the depicted embodiment by the inclusion of a plurality of spaced ribs 42 extending vertically from proximal the bottom 16b to proximal the upper edges of sidewalls 16a. Although the present invention contemplates any side wall configuration adequate to resist the side and bottom loading, the depicted embodiment includes ribs 42 having a tapered section 42a at their respective upper ends, blending back into the generally planar upper edges of sidewalls 16a. In the depicted embodiment, a slit 42b is formed in section 42a to accommodate material movement resulting from the forming process. The number, spacing and location of ribs may vary as appropriate.

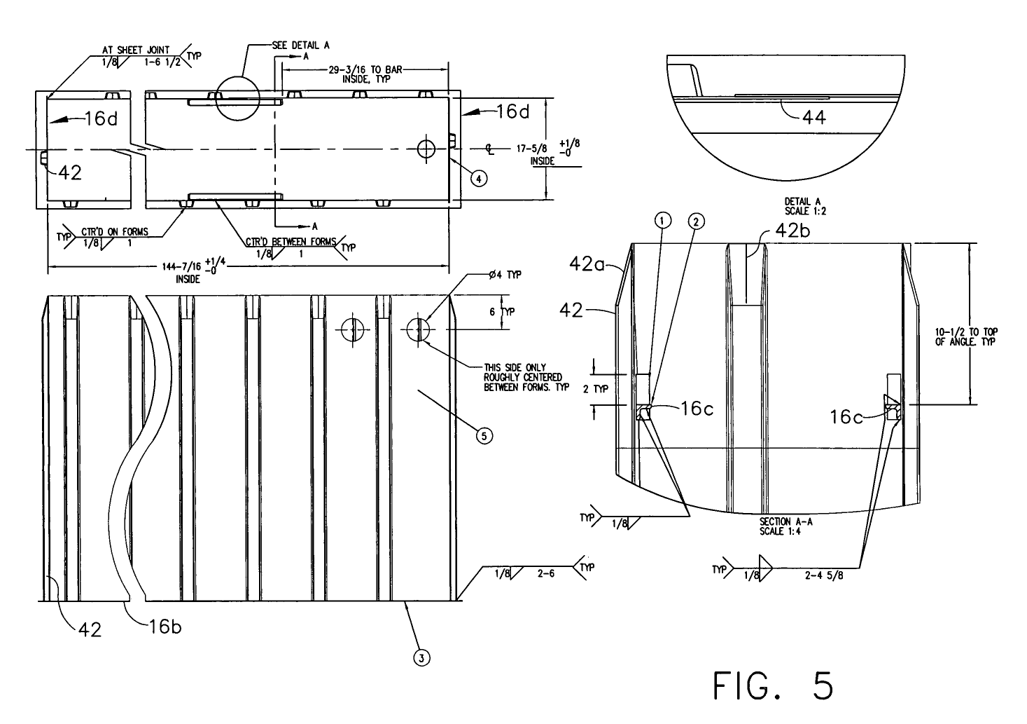

As seen in FIG. 5, in the depicted embodiment: housing 16 also includes an internal frame 16c which provides support to sidewalls 16a. Frame 16c may be located in any desired location to provide such support, including for example, proximal the lower portion of sidewalls 16a.

Also seen in FIG. 5, in the depicted embodiment: housing 16 is made of sections which overlap vertically, such as shown at 44, which are skip welded. The ends 16d are identical sections, including two 90° corners and “legs” of different length extending therefrom, with side sections welded to each leg. The overall length of housing 16 is selected as desired and the appropriate number of side panels assembled together with the ends 16d.

A coating is applied to the inside and outside of housings 16 and 18, which comprises a thin (about ⅛ inch) high dielectric material. As will be readily appreciated, the coating resists corrosion of the steel housing 16. The coating is also beneficial in allowing the use of skip welding, sealing the seams in between welds.

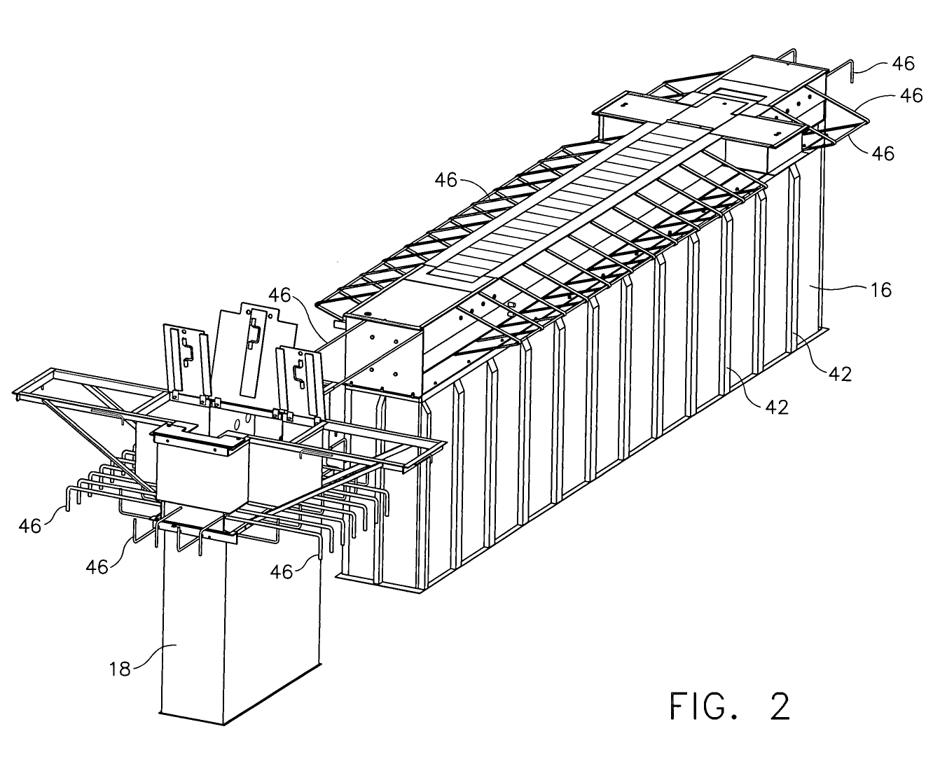

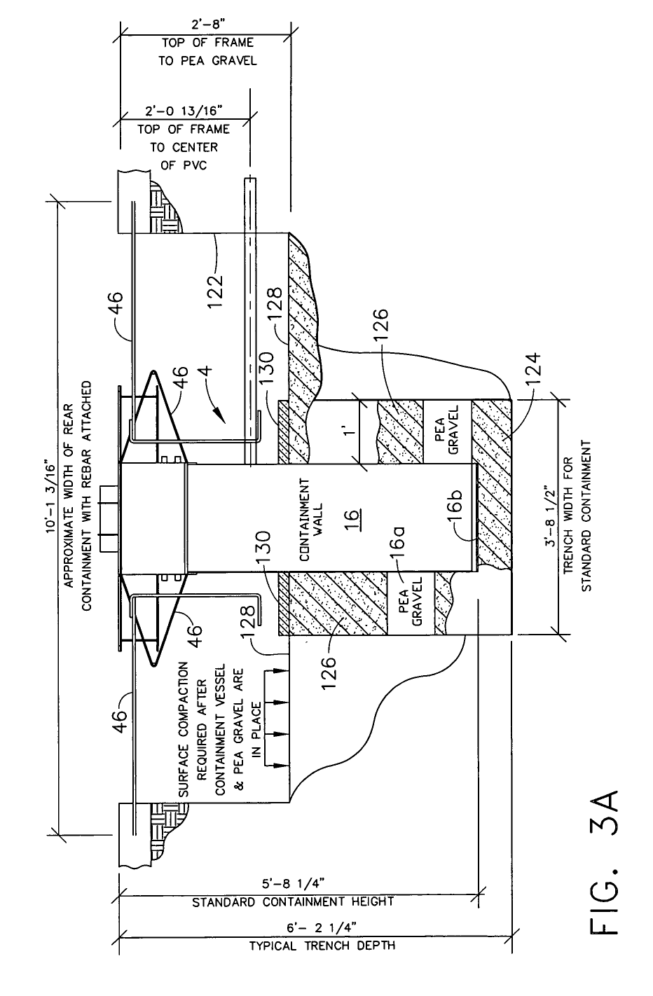

Referring to FIGS. 2-4, as mentioned above, lift 2 includes structure which interact in conjunction with the lift bay floor 40 to transfer substantially all of the load to the lift bay floor 40. In the depicted embodiment, floor 40 is constructed to have the necessary structural capacity with the necessary underlying supporting layer providing the foundational support. In the depicted embodiment, housings 16 and 18 include members 46, including reinforcing bars (also known as rebar), extending from the upper portion of the housings.

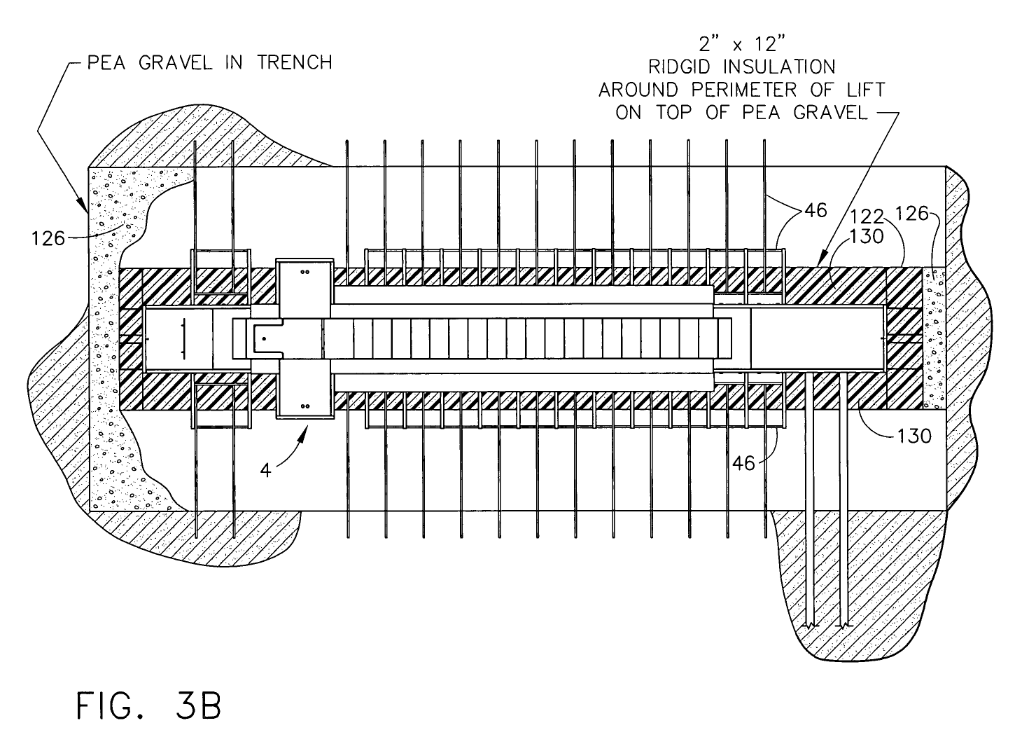

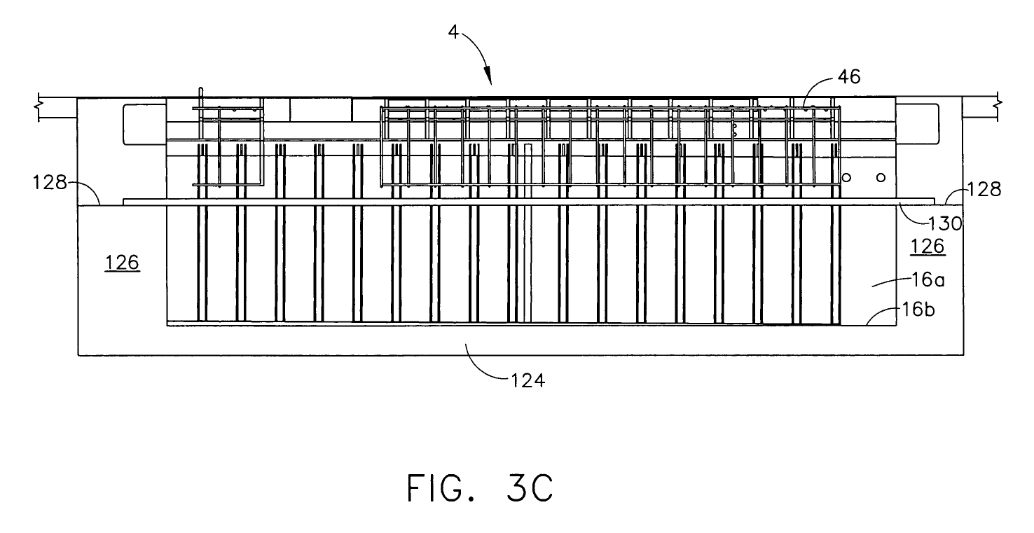

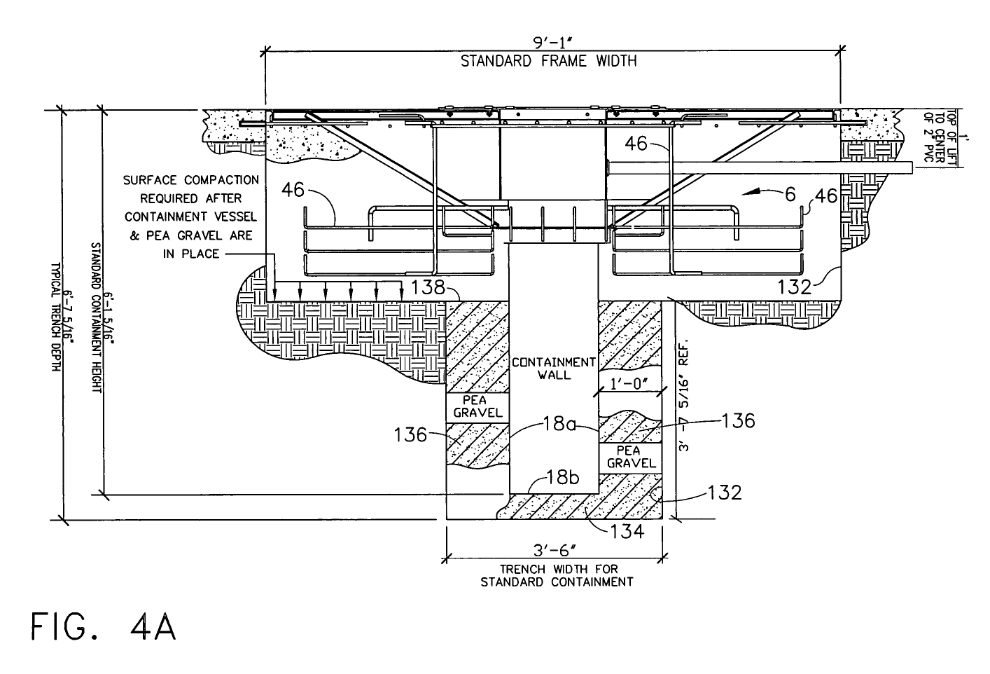

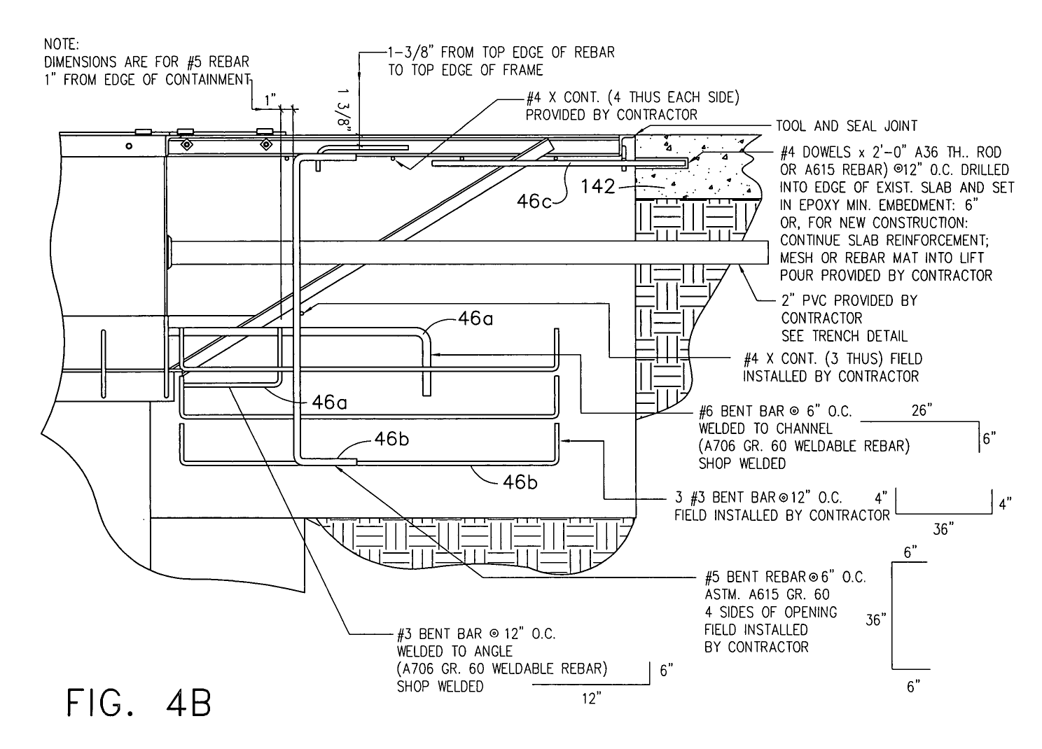

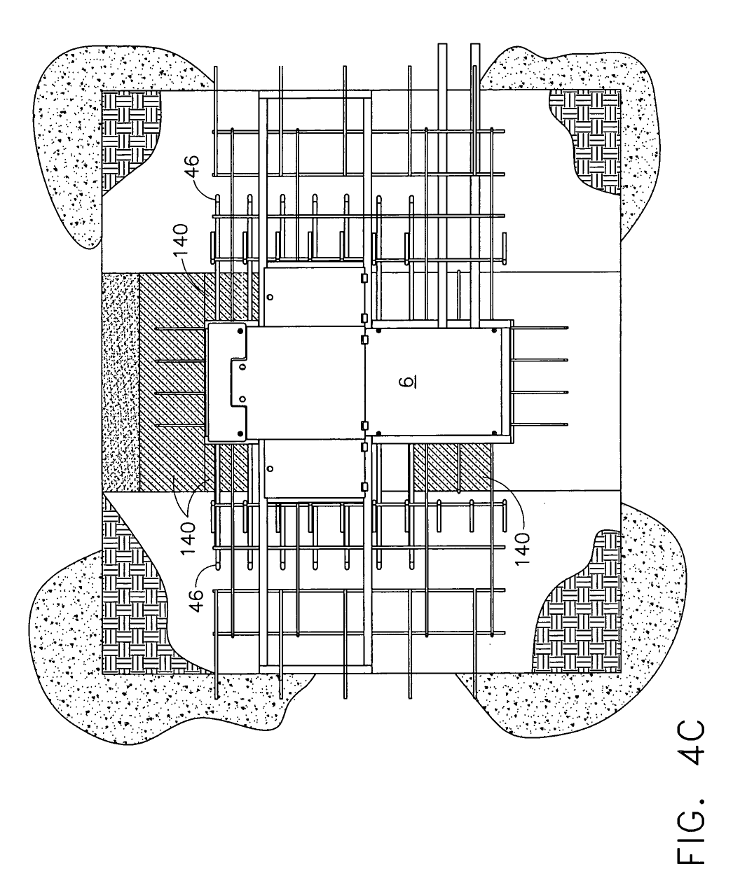

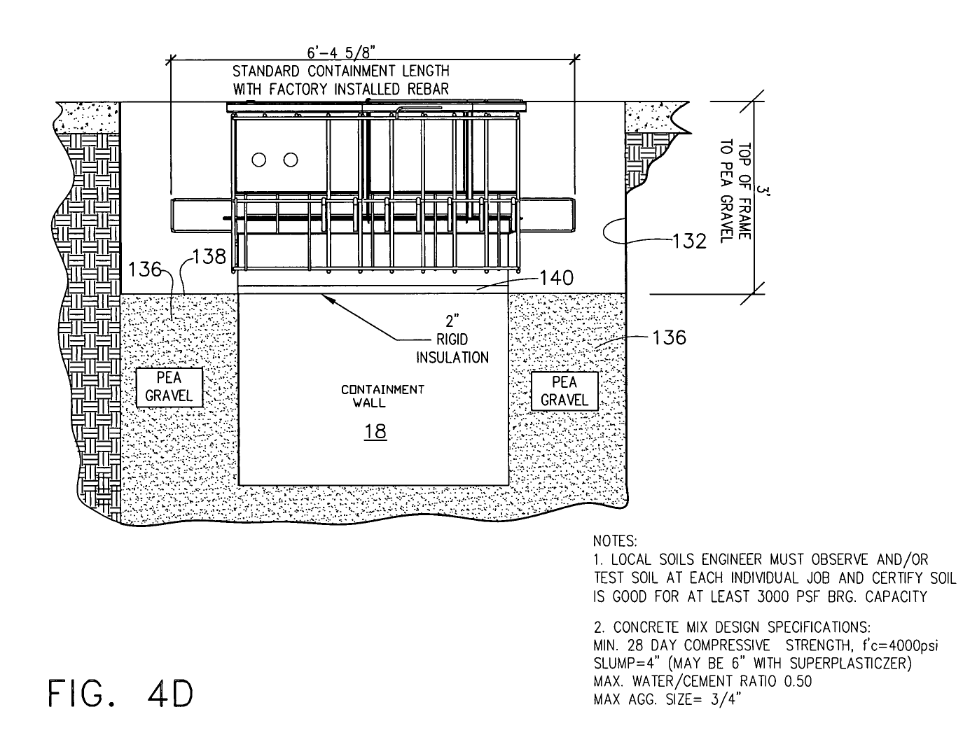

The physical characteristics of such members, such as location, size, quantity and orientation, are determined so as to provide the necessary interaction between them and the surrounding lift bay floor 40 to provide the load transfer required. As seen in FIGS. 3 and 4, rebar is arranged in a pattern sufficient to provide the necessary structural strength and integrity for lift bay floor 40 to support lift 2 with jacks 12 and 14. FIGS. 3 and 4 illustrate the typical equipment foundation requirements, including the placement of gravel and other typical material. Although rigid insulation is illustrated adjacent the housings 16 and 18, such is not necessarily placed there. The thickness of the surrounding lift bay floor 40 slopes from its nominal thickness to an increased thickness proximal the housings 16 and 18. Although FIG. 3 illustrates pea gravel disposed well beyond the sides of the housing 16, extending beyond the top of the trench in which housing 16 is disposed, such is not necessarily placed there.

With such construction, full support of lift 2 and jacks 12 and 14 is provided by the lift bay floor 40. The modules, each being self contained, allows great flexibility in locating and installing the lift. Since the support is provided by the lift bay floor 40, there is no need to pour a structural concrete floor in the pit bottom for lift support, wait several weeks for it to cure, pour pit walls, wait several weeks for curing, and then pour the lift bay floor also followed several weeks for curing. The present invention allows the inground lift to be installed with a single pour, significantly reducing the installation time. It also makes retrofitting old lifts much easier.

Returning to FIG. 1, modules 4 and 6 each include a respective power unit, only seen as 8 in FIG. 1 for module 4. In the depicted embodiment, power unit 8 is fixedly mounted, and does not move with jack 12. Power unit 8 includes a motor and hydraulic pump which supplies hydraulic fluid to and from telescoping cylinder 48. Jack 12 includes telescoping locking leg 50, which is connected at the top to saddle 52 which is carried by cylinder 48. Locking leg 50 is designed to hold saddle 52 (and any vehicle thereon) in place in the event of loss of pressure within cylinder 48. Jack 14 has the same cylinder and locking leg construction.

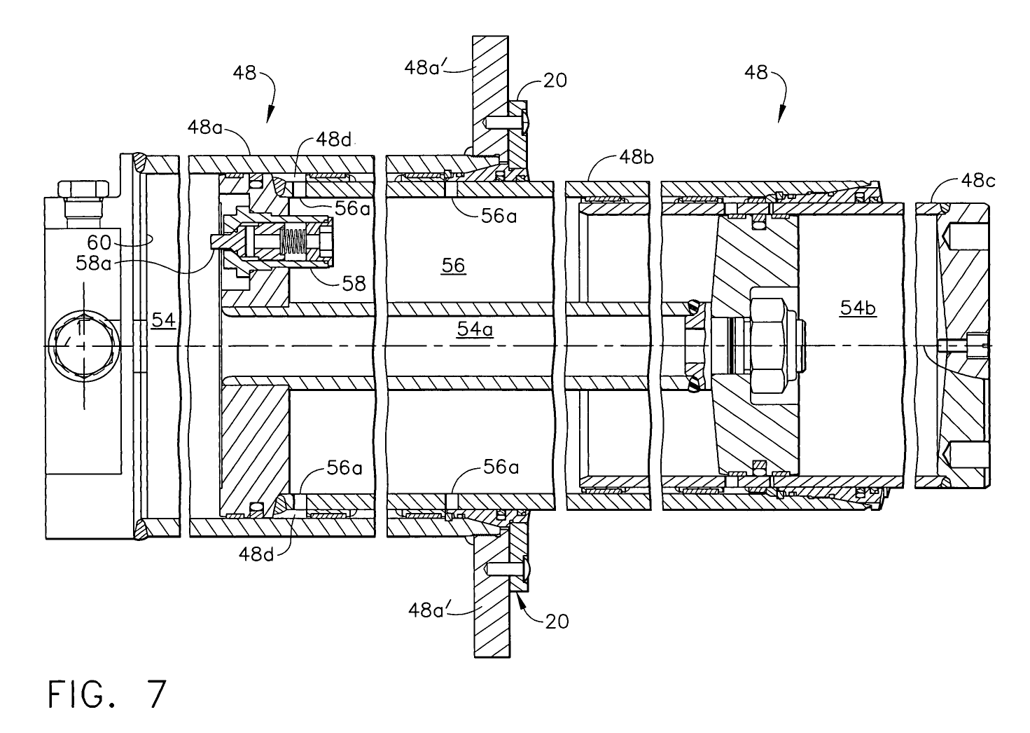

Referring to FIG. 7, cylinder 48 includes three concentric sections 48a, 48b and 48c. Section 48a includes a flange 48a′ which is carried by carriage 20. Upon the application of pressurized hydraulic fluid to the internal cavity 54 of cylinder 48, sections 48b and 48c extend in synchronized motion from section 48a. Synchronized relative movement of ail sections of cylinder 48 avoids the bump that typically occurs at the transition between sections when a multiple section cylinder extends one section at a time, and avoids the control difficulties associated therewith, such as stage capacity issues, speed changes, abrupt stops.

The fluid pressurizes cavities 54, 54a and 54b, which are in communication with each other. Synchronous motion results from fluid located in cavity 48d being forced into internal cavity 56, which is not in fluid communication with cavities 54, 54a and 54b, through passageways 56a. This fluid forces section 48c to extend the same amount in order to maintain internal cavity 56 at a constant volume. Since the annular area of cavity 48d is equal to the annular area of the difference between the inner diameter of section 48b and the inner diameter of section 48c, the linear displacement of sections 48b and 48c are equal. Spring loaded valve 58 includes stem 58a which contacts wall 60 when the sections 48a, 48b and 48c are collapsed within each other, thereby equalizing the pressure between cavities 54, 54a and 54b, and cavity 56.

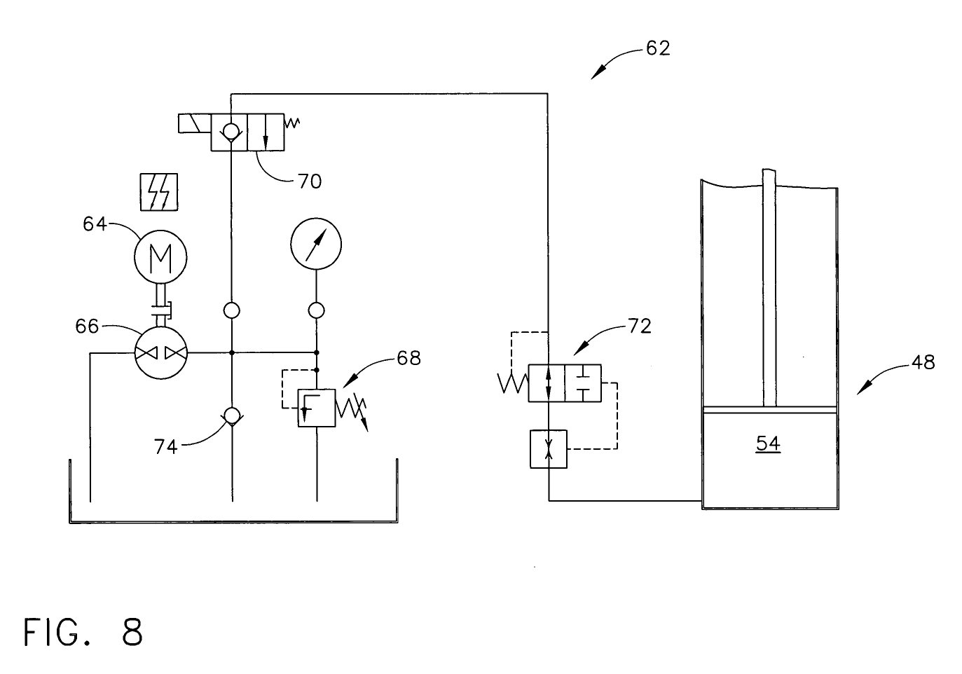

FIG. 8 diagrammatically illustrates a hydraulic circuit, generally indicated at 62, of the inground lift 2 of this depicted embodiment. shown in FIG. 1. Motor 64 drives hydraulic pump 66. Pressure relief valve 68 prevents overpressure. When motor 64 is on, rotating to raise jack 12, fluid flows past air pilot operated check valve 70, in the position shown, past velocity fuse 72 (which prevents hydraulic pressure from flowing from cylinder 58 too fast in the event of a leak downstream of fuse 72) and into cavity 54 of cylinder 48, thereby raising it. Each motor/pump is controlled by a respective variable frequency drive (VFD) motor controller to effect raising and lowering of each lift.

Jack 12 is powered down. Valve 70 is moved to the down position, and motor 64 is energized to run pump 66 in the opposite direction, thereby pulling fluid from cylinder 54. Valve 74 prevents pump 66 from removing the fluid too fast, preventing a vacuum.

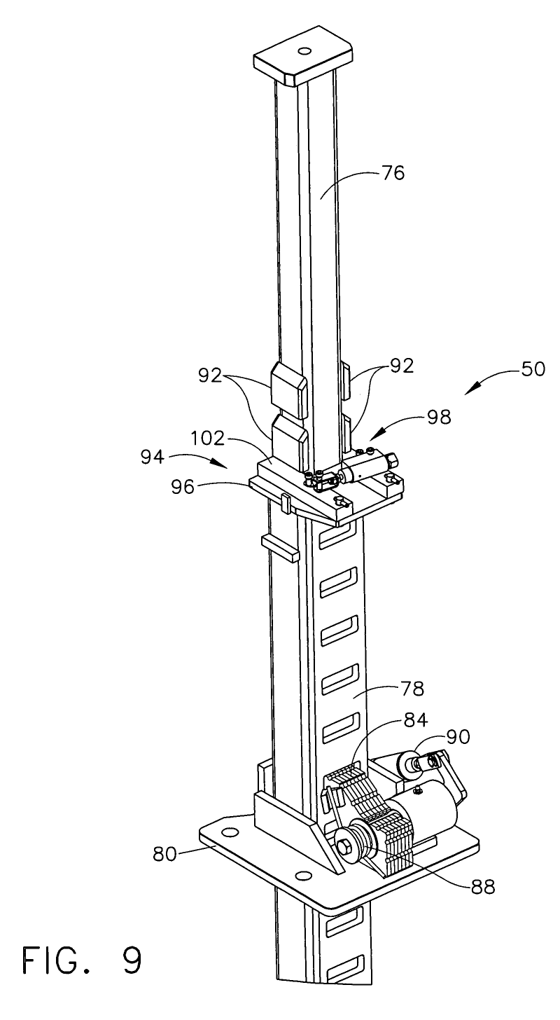

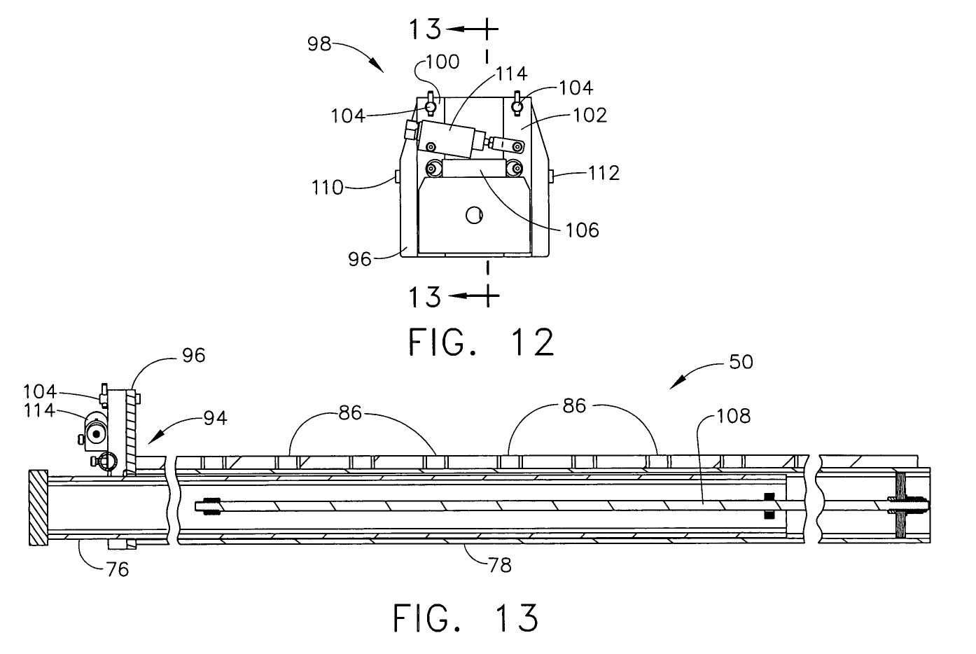

As shown in FIGS. 9-13, each jack includes a respective telescoping locking leg 50, which prevents unintended downward movement of the lift. The telescoping aspect of telescoping locking leg 50 allows an overall shorter length as with telescoping cylinder 48, thereby reducing the depth of the trench that has to be dug for modules 4 and 6.

Telescoping locking leg 50 is carried by flange 82 extending from the outside of cylinder 48, and includes upper leg 76 which is telescopingly disposed relative to and, in the depicted embodiment, within lower leg 78. Lower locking mechanism 80 is carried by flange 82, and guides lower leg 78 as it moves through the opening (not numbered) as lift 12 is raised and lowered. Lower locking mechanism 80 includes pivoting latch 84 which is normally biased into engagement with a series of vertically aligned windows and steps 86, resembling a ladder, by spring 88. Latch 84 is Engagement of latch 84 with any of the steps 86 prevents lift 12 from lowering beyond that step, thereby providing a positive mechanical lock, preventing downward movement of the lift. In order to lower the lift intentionally, latch 84 is held in its disengaged position by actuation of air cylinder 90.

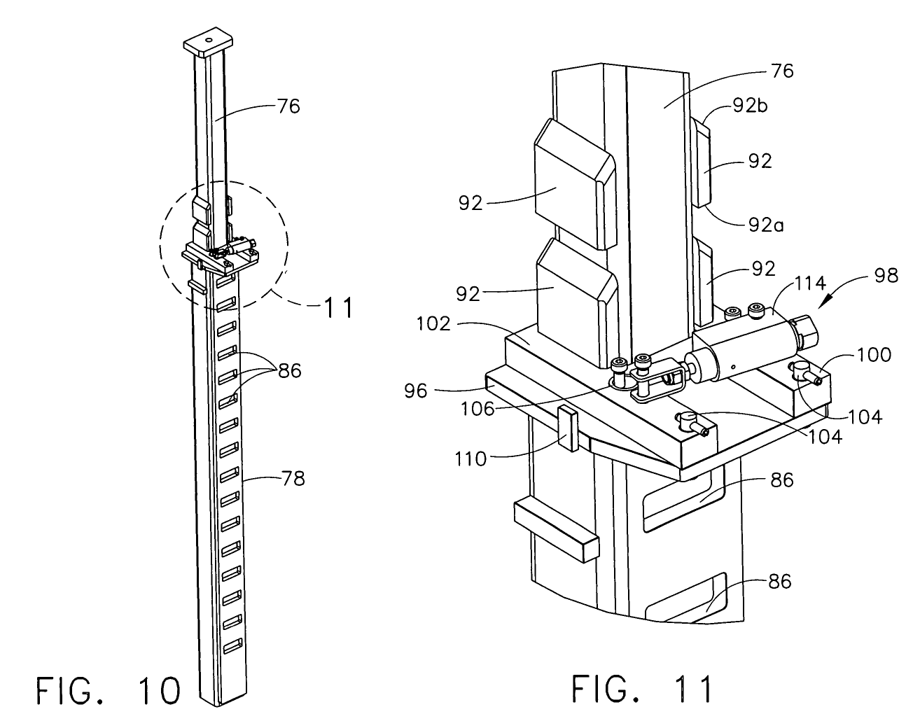

Upper leg 76 includes a plurality of stop blocks 92 disposed as pairs on opposite sides of upper leg 76. Lower edge 92a of each block 92 is generally flat and perpendicular to the vertical sides of upper leg 76, while upper edge 92b of each block 92 is inclined. Upper end 94 of lower leg 78 includes a flange 96 which upper locking mechanism 98. Upper locking mechanism 98 includes two spaced apart pivotably mounted latches 100 and 102 which are pivotably mounted to flange 96 by pivots 104. Latches are biased toward each other by spring 106 into an engaged or locked position as best seen in FIG. 12. In the engaged position, the edges of latches 100 and 102 are parallel with the corresponding adjacent surface of upper leg 76. As upper leg 76 is extended, upper edges 92b of each pair of blocks will force latches 100 and 102 outwardly as blocks 92 pass. Latches 100 and 102 will return to the engaged position once they reach the lower edges 92a of blocks 92.

As lift 12 is raised, upper leg 76 will be the first leg to move, traveling upwardly by virtue of being connected to saddle 52. Stops 92 are spaced about 24 inches down from the top of upper leg 76 and the safety stops are not needed before upper leg 76 has extended that far. Once the extension of upper leg 76 has caused latches 100 and 102 to reach the last set of blocks 92, with latches 100 and 102 in the engaged position, upper leg 76 will stop telescoping from lower leg 78 and lower leg 78 will begin extending from lower locking mechanism 80. Upper leg 76 is interconnected to lower leg 78 by rod 108 which allows movement therebetween until upper leg 76 has extended the desired/designed amount. At that point, rod will pull lower leg 78 upward as saddle 52 pulls upper leg 76 upward with it.

In order to lower the lift intentionally, latches 100 and 102 are held spaced apart, constrained from over travel by stops 110 and 112 by actuation of air cylinder 114, which is pivotably connected to each latch 100 and 102.

When motor 64 is energized to raise jack 12, the configuration of lower locking mechanism and upper locking mechanism permits the upward movement without applying any pressure, with latch 84 periodically engaging steps 86 and latches 100 and 102 engaging lower blocks 92. When motor 64 is energized to lower jack 12, air cylinders 90 and 114 are energized simultaneously and latches 84, 100 and 102 are held in disengaged positions allowing telescoping locking leg 50 to retract.

The vertical positions of jacks 12 and 14 are respectively monitored by any appropriate devices, such as string potentiometers (not shown).

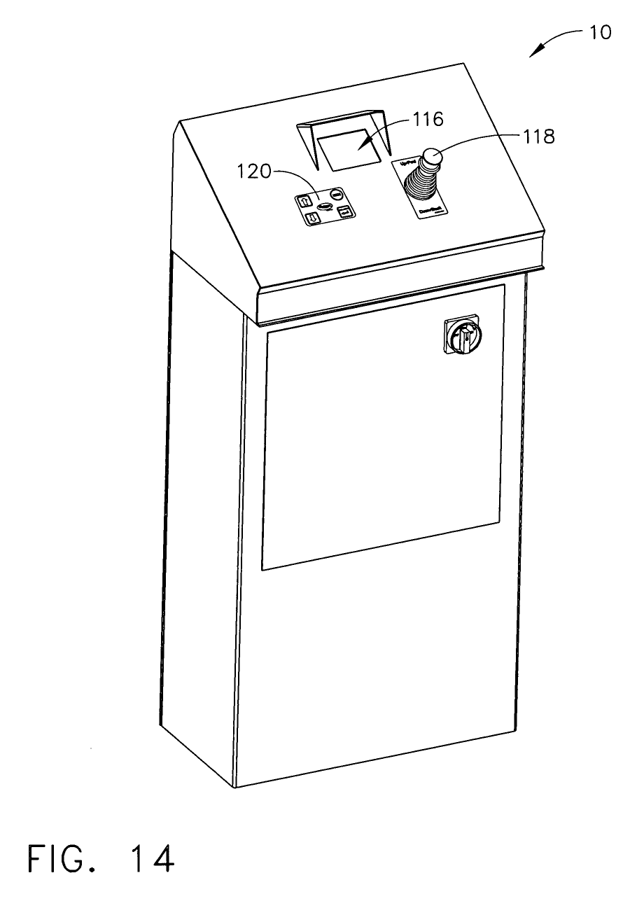

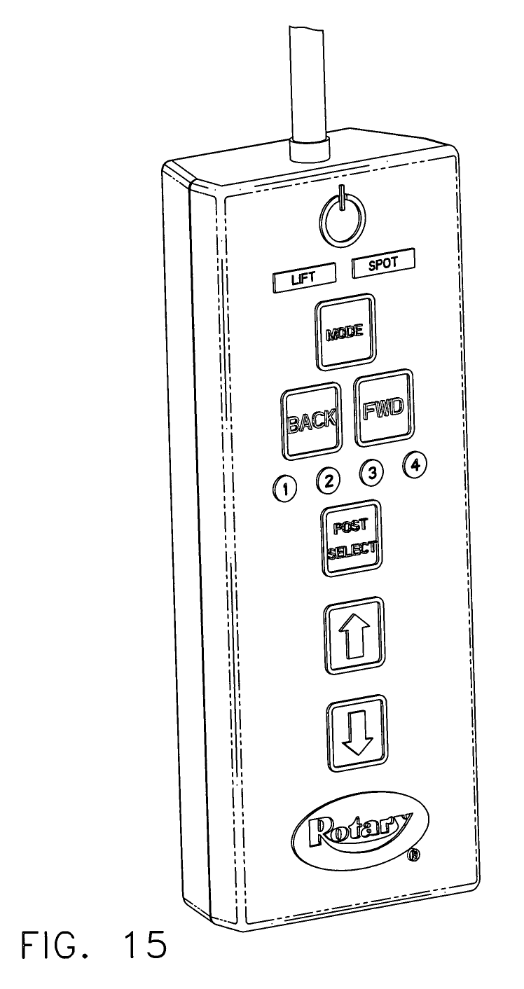

Referring to FIG. 14, there is shown a perspective view of the control panel 10 of lift 2. Control panel 10 includes display 116, joy stick 118, and key pad 120. An alternate control panel is illustrated in FIG. 15.

In the depicted embodiment, key pad 120 comprises four electric switches or keys generally corresponding to the keys disclosed in U.S. patent application Ser. No. 10/055,800 for Electronically Controlled Vehicle Lift And Vehicle Service System. In the embodiment depicted in this application, the controls disclosed in U.S. patent application Ser. No. 10/055,800 and U.S. patent application Ser. No. 10/123,083, are used herein, with the appropriate modification to accommodate the operation of the present lift. For example, since the present lift may include an odd number of lifts, synchronization may be done in many different ways, such as controlling two of the lifts relative to one.

When the control of lift 2 is in the operation mode, rather than an information mode, the lift 2 may be placed in the positioning mode or the lifting mode. In the positioning mode, the joystick is used to place the adapters in contact with the axle or other part of the vehicle being lifted. This involves the horizontal positioning of any horizontally moveable lift, such as jack 12, and the vertical positioning of each jack to the proper vehicle contacting height. After proper positioning, the control is switched to the lifting mode and the vehicle is lifted. In the positioning mode, the control allows selection between horizontal and vertical positioning for any jack which is horizontally moveable, and selection of vertical positioning for any fixed jack.

In the depicted embodiment, positioning is controlled by the joystick in combination with the key pad for appropriate mode selections. In the two jack configuration depicted, there are three screens: one for vertical positioning of the front, fixed jack, one for vertical positioning of the rear jack, and one for horizontal positioning of the rear jack.

In the depicted embodiment, to set the position for the rear jack, the control system is scrolled to the appropriate screen, and the joystick is used to make the adjustment. In the horizontal positioning mode, the VFD controls the horizontal positioning motor to move the jack 12 to the desired horizontal position. Using the position sensor, such as the output of the string potentiometer, the control can determine the horizontal position. The control may be programmed with specific horizontal locations for locating the jack, which can remember frequently used horizontal locations such as corresponding to wheelbase dimensions. This may be done, for example, by programming stop points at which the jack is stopped, and following release and reengagement of the deadman joystick, caused to move until the next programmed stop location is reached, going through this process until the desired programmed stop location is attained. With appropriate safety safeguards, the control could drive the lift to a preprogrammed horizontal position rather than stopping at each point. In one embodiment, all programmed stop locations are set to the maximum position, rendering them ineffective.

Since the control is done through the respective VFD for each module, the current to the motor may be controlled precisely. The control can monitor the current draw and stop the movement in the event that too much current is drawn, such as in an over torque situation if the lift encounters an obstruction or if the lift reaches either end of its horizontal travel and is physically unable to move further. If an over current condition is encountered, the lift control shuts down operation and goes into a troubleshooting mode using screen displays to guide the operator to resolution of the problem.

Once the jack 12 is in the proper horizontal position, the vertical position of jack 12 is adjusted. The control is toggled to the appropriate mode, and the joystick is used to raise the saddle. The same VFD drives the vertical movement motor and the control torque limits the motor by limiting current to prevent any lifting of the vehicle with just the one lift. This allows the operator to bring the adapters into the proper contact with the axle.

The other jacks are then adjusted to the appropriate position. In the depicted embodiment, the control is switched to position front jack 14 vertically to bring the adapters into the proper contact with the axle. The torque is limited by limiting the current to prevent any lifting of the vehicle.

Once the jacks are in proper position, the control is switched to the lifting mode. Since for most vehicles, the axles are not in the same plane, the control establishes an offset for maintaining a level datum referenced to the vehicle, using the position information indicated by each jack's vertical position sensor, in the depicted embodiment a string potentiometer. It is noted that any suitable position sensor or control algorithm to determine position may be used.

In the lifting mode, each jack may be controlled individually, such as when there is a need to raise one axle relative to the other. The default lifting mode, though, is the raising of all jacks synchronously. In the default “all” mode, the joystick is moved to raise or lower all lifts together. Preprogrammed heights may be provided. In the lift mode, the VFD is not current limited. Although not as accurate as current limited control, each power unit has its own hydraulic relief valve.

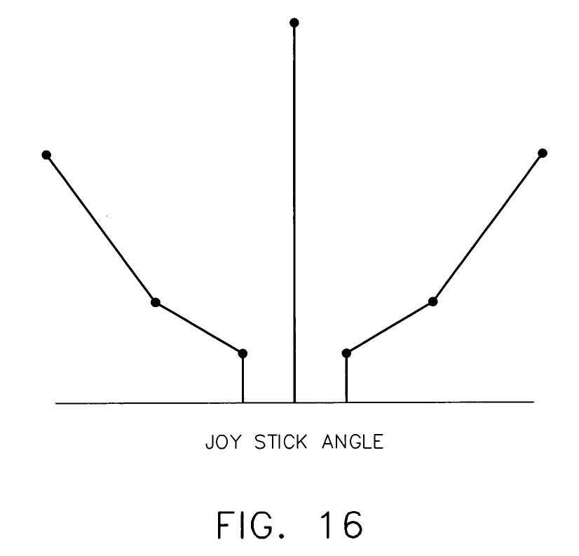

The rate of adjustment made by the joystick varies with the angle of the joystick, as seen in FIG. 16. The rate of adjustment is programmable as desired.

To lower the lifts, the respective VFDs of each module drives the motors in reverse. In one embodiment, each motor is driven to matching speeds. Other control algorithms may be used. For example, the approximate load could be determined by the current and speed. Different down gains could be used in the control algorithm.

In summary, numerous benefits have been described which result from employing the concepts of the invention. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims appended hereto.

What is claimed is:

1. An inground lift for use in a lift bay having a lift bay floor, said lift comprising:
a. at least one vertically moveable jack having a distal end; and
b. structure configured to interact with said lift bay floor to transfer substantially all load placed on said distal end of said jack to said lift bay floor.
